(19) United States
(12) Patent Application Publication
(10) Pub. No.: US 2007/0050371 A1
(43) Pub. Date: Mar. 1, 2007

(54) Interacting with an online database through a variety of communications media

(75) Inventors: Theodore Clayton Johnson, Medina, WA (US); Peter Christopher Mullen, Seattle, WA (US); William Clayton Knight, Bainbridge Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Trumba Corporation, Seattle, WA (US)

(21) Appl. No.: 11/213,081

(22) Filed: Aug. 26, 2005

(51) Int. Cl. G06F 17/30

(52) U.S. Cl. 707/10

(57) ABSTRACT

A method for interacting with an online database through a variety of communications methods is described. Using e-mail programs, instant messaging applications, or SMS for mobile devices, a user of an online service composes and sends a language-based text message to an online service. A user services application implemented by the online service reads the incoming messages, verifies rights to the requested data, and determines whether the text message is a query or command. If the rights to the requested data have been confirmed by the mail reader application, the requested data is returned to the user in response to a query or the change is made to a record in the database in response to a command. In the case of e-mail, a confirmation step may be required in order to prevent spoofed e-mail commands.

### FIELD OF THE INVENTION

The present invention relates to computer networks, communication systems, and database management systems.

### BACKGROUND OF THE INVENTION

The increasing availability and use of broadband services and the corresponding growth in the number of online services has resulted in the phenomenon that consumers are living more and more of their lives “online”. Computer users establish accounts with Web-based businesses to obtain news or other event information, purchase goods, pay bills, communicate with other computer users, and perform a variety of other tasks. Typically, in order to access an online service and perform a desired task, a user must initiate a browser application on an Internet enabled device, direct the browser to the Web site, log in, and locate the desired data within the Web application. Furthermore, unless the Internet-enabled device is a computer, as opposed to a mobile device, it may be difficult to achieve the desired task, as browser functionality on a mobile device typically does not support most functions of an online application. Accordingly, mobile device users of the online service may be limited in the ability to interact with an online service.

Thus, there is a need for a system for individualized communication between a user and an online database that will enable queries or commands submitted to an online database through a variety of communications media.

### SUMMARY OF THE INVENTION

A system for interacting with an online database is provided. In one aspect of the invention a user creates an ad hoc, language-based query or command that can be sent through one or more communications media such as e-mail, short messaging service (“SMS”), instant messaging (“IM”), or other messaging delivery service to a desired online service. In another aspect of the invention, the query or command is directed to a user-specific domain maintained by the online service that incorporates a unique uniform resource locator and e-mail address. In a further aspect of the invention, the query or command is directed to a user services address maintained by the online service that incorporates an instant messaging ID and or SMS parser. In a still further aspect of the invention, some portion of the records maintained in the database may be retrieved or altered, according to the user's rights and intent.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an online service architecture including a number of client computing devices and an online service in accordance with an aspect of the present invention;

FIG. 2 is a block diagram of the online service architecture of FIG. 1 illustrating the processing of a database request from a client computing device in accordance with an aspect of the present invention;

FIG. 3 is a flow diagram illustrative of a database processing routine for a user-generated query or command submitted in electronic mail format in accordance with an aspect of the present invention;

FIG. 4 is a flow diagram illustrative of a processing routine for a user-generated query or command submitted in instant messaging format in accordance with the present invention; and

FIG. 5 is a flow diagram illustrative of a processing routine for a user-generated query or command submitted in short messaging service format in accordance with the present invention.

### DETAILED DESCRIPTION OF THE PREFERRED EMBODIMENT

Generally described, the present invention relates to a system and method for processing database requests from a network-based database. More specifically, the present invention relates to a system and method for processing database queries and database commands transmitted via a communication medium to a network-based database. Although the present invention will be described with regard to various communication media and illustrative embodiments, one skilled in the relevant art will appreciate that the disclosed embodiments are illustrative in nature and should not be construed as limiting.

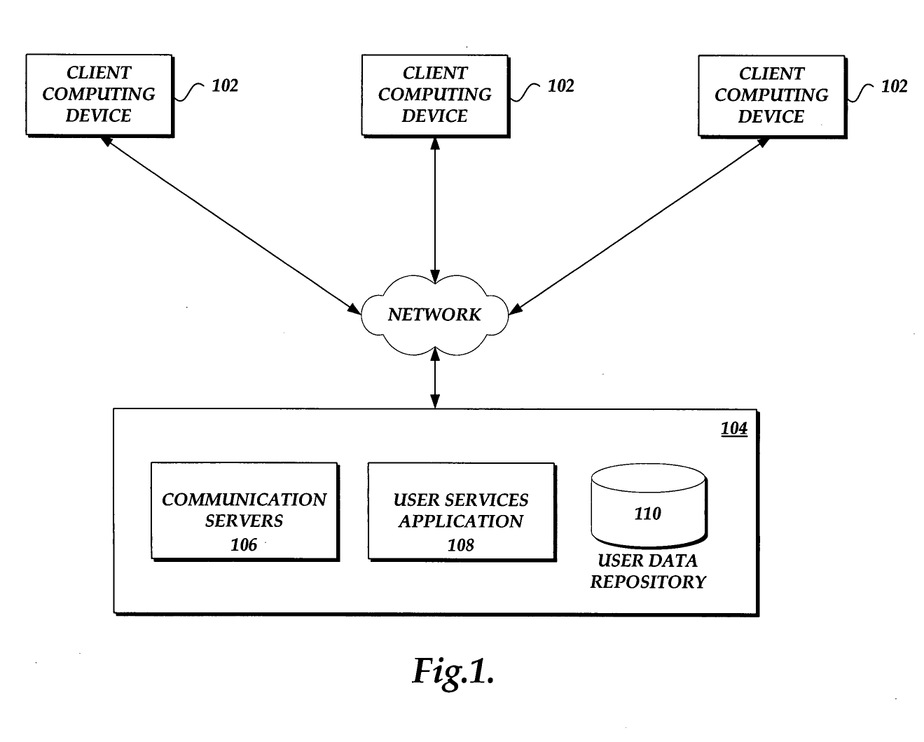

With reference to FIG. 1, a block diagram of an illustrative architecture for an online communication network 100 is shown. The online communication network 100 includes a number of client computing devices 102 that include software applications for accessing a communication network, such as the Internet, instant messaging (IM) networks, text messaging networks, and the like. In an illustrative embodiment of the present invention, the client computing devices 102 include, but are not limited to, personal computers, mobile computing devices, mobile telephones, hand-held computing devices, terminals, and the like.

The online communication network 100 can also include an online service 104 for processing database communication requests from the client computing devices 102. The online service 104 can include a number of communication servers 106, such as Web servers, e-mail servers and/or other communication devices that facilitate receipt of communications from client computing devices 102 in several communication media. The online service 104 also includes a user services application 108 that processes the client communication to validate the communication, authenticate the user request, and/or process the communication as a data request or a data modification command. In an illustrative embodiment of the present invention, the online service may maintain a user services application 108 for a specific type of communication media, such as an e-mail user services application 108. Alternatively, the online service 104 may have a user services application 108 that can process requests originating from different types of communication media. The online service 104 further includes a user data repository 110 that corresponds to user-specific data, user profiles for accessing public information, and user data to authenticate a user. In an illustrative embodiment of the present invention, the user data repository 110 may correspond to a number of database servers configured locally or distributed across a network.

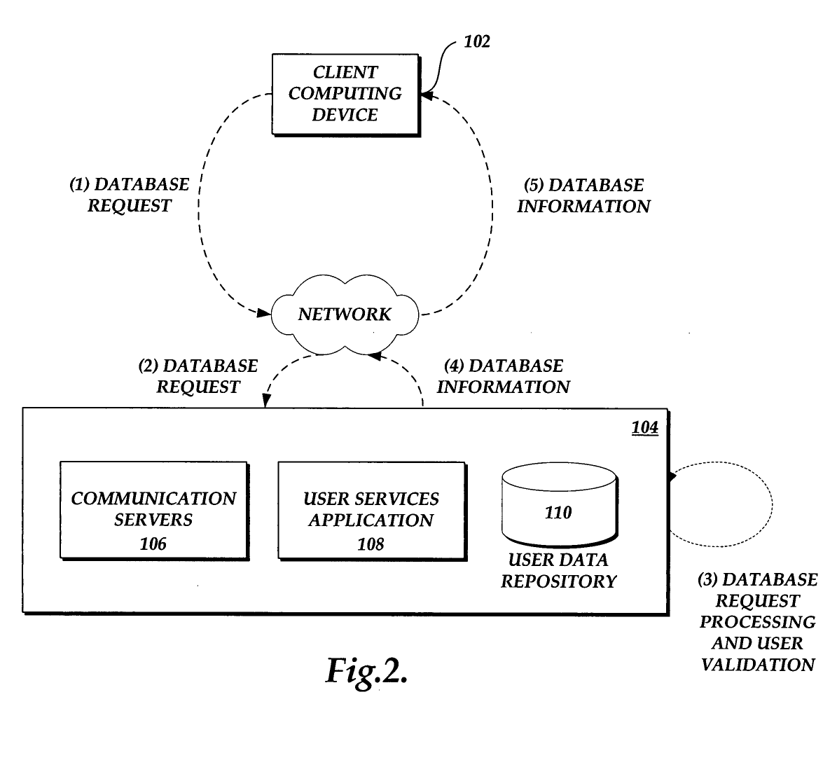

With reference now to FIG. 2, in accordance with an illustrative embodiment of the present invention, a client computing device 102 transmits a database request via a communication media, such as electronic mail, short message service, instant message and the like. The database request can correspond to a non-Internet based request. The user services application 108 obtains the database request from a corresponding communication server 106. The user services application 108 processes the database request to ensure that the database request corresponds to a valid user of the online service 104. The user services application 108 can also authenticate the identity of the database request sender. Thereafter, the user services application 108 can process the database request as a query for information from the user data repository 110. In one embodiment, the query for information may correspond to private information corresponding to a user account. In another embodiment, the query for information may correspond to public or semi-public information corresponding to a multi-user account. In another embodiment, the user services application 108 can process the database request as a command to modify information from a user account, such as a modification or deletion of existing information or the addition of additional information. The user services application 108 can then return a result of the processing of the database request in the form of the requested information or the confirmation of an executed database command. The user services application 108 can transmit the result via the same communication media used to transmit the request or an alternate communication medium.

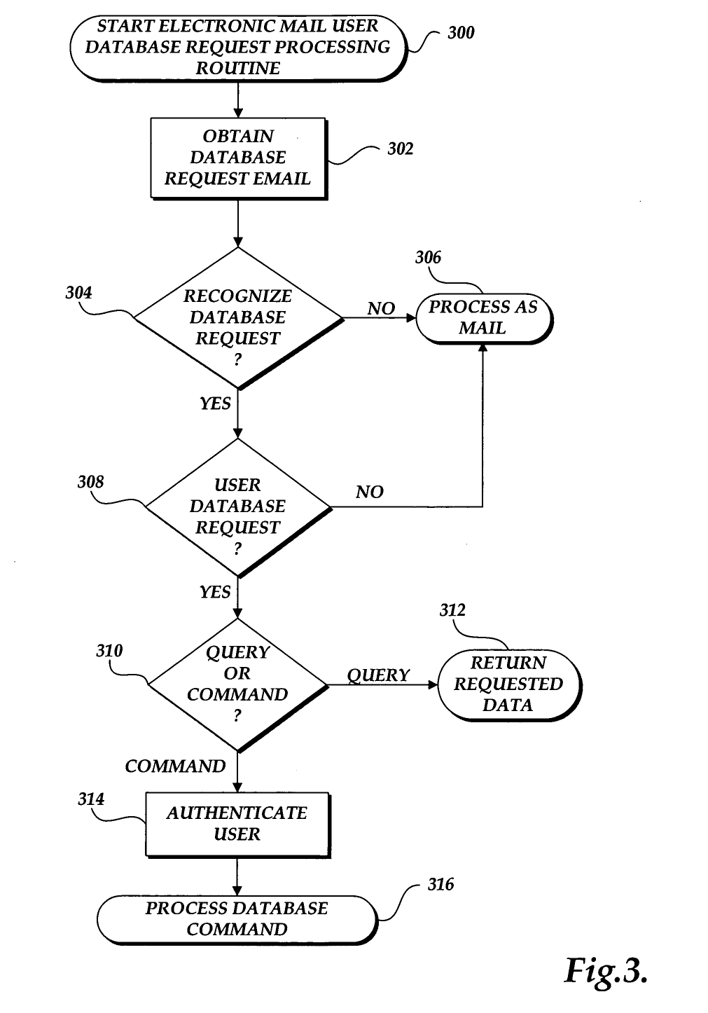

As described above, in an actual embodiment of the present invention, a user-generated, query or command is submitted to the online service 104 via an e-mail. FIG. 3 is flow diagram of an illustrative processing an electronic mail database request processing routine 300 implemented by the online service 104 in accordance with an aspect of the present invention. At block 302, the user services application 108 obtains an e-mail corresponding to a database request. In an illustrative embodiment, the e-mail is generated by a user on a client computing device 102 utilizing an e-mail application program. As in known to those skilled in the art, an e-mail client or, mail user agent (“WUA”), is used to send the e-mail to the Internet service provider (“ISP”) that used to connect the client computing device 102 to the Internet. In turn, the ISP utilizes a mail transfer agent (“MTA”) to route the e-mail to the MTA corresponding to a communication server 106 on the online service 102. The user services application 108 obtains the e-mail from the corresponding communication server 106. In an actual embodiment of the present invention, the e-mailed query or command may be text found either in the subject heading or body of the e-mail message. For example, the database request may correspond to a predetermined template utilized by a client computing device 102.

At decision block 304, a test is conducted to determine whether the user services application 108 recognizes the database request as a query or command. If the database request is not recognized, the text of the e-mail message can be forwarded to an e-mail account associated with the user domain to which the query or command was directed and the routine 300 ends at block 306. Alternatively, if the user services application 108 recognizes the query or command, at decision block 308, a test is conducted to determine whether the originating e-mail address is associated with a user that has rights to the requested. In an illustrative embodiment of the present invention, the user services application 108 utilizes the user data repository to determine whether the originating e-mail address corresponds to a user of the online service 104. If the e-mail is not associated with a user that has rights, the text of the query or command is forwarded to an e-mail account associated with the user domain to which the query or command was directed at block 306.

If at decision block 308, the originating e-mail address is associated with a user that has rights to the requested data, at decision block 310, a further test is conducted to determine whether the request is a query or command. In an illustrative embodiment, the user services application 108 parses the e-mail for relevant query or command statements and composes a digest request. In another embodiment, the user services application 108 can scan for specific identifiers or metadata to identify a type of database request. If the request is a query, the user services application 108 conducts the corresponding query from the user data repository and returns the data at block 312. As will be explained in greater detail below, the user query can correspond to a query of a single user or multiple user data sets. In some instances, a duplicate copy of the requested data may be sent to one or more additional users including the primary user. If at decision block 310, the request is a command (reflective on an intent to make a change to a record in the database), at block 314, an optional additional user verification step may be required. In an illustrative embodiment, an e-mail message may be forwarded to an e-mail account associated with the user domain to which the domain is directed. In an alternative embodiment, additional or alternative forms of user verification may also be implemented. For example, the user services application 108 may prompt a user for various user identification information, such as PINS, passwords, smart cards, and the like. If the user is authenticated, at block 316, the user services application 108 processes the database command and the routine 300 ends.

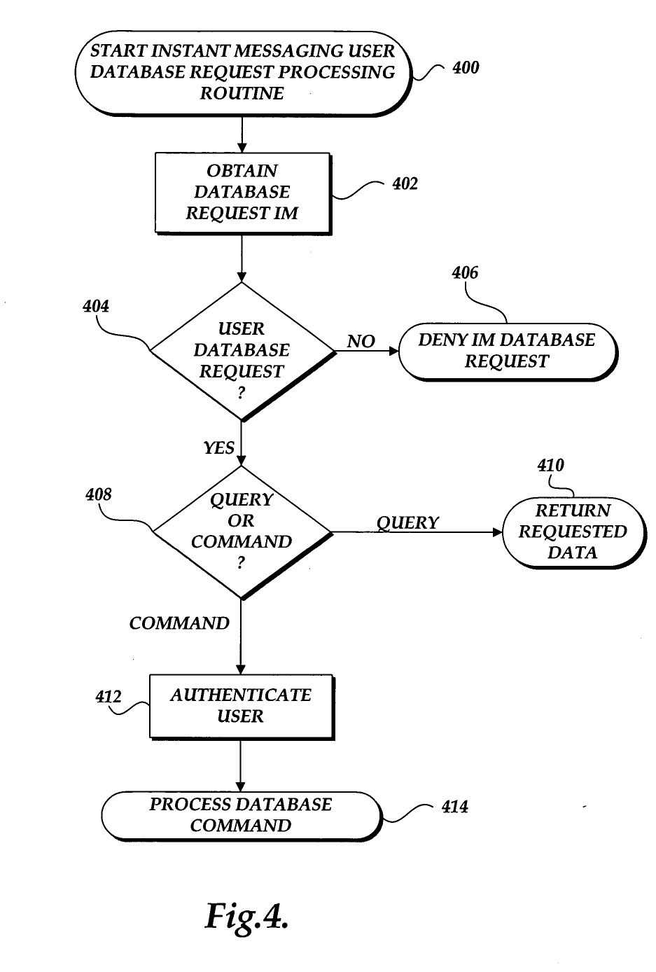

FIG. 4 is an illustrative processing an instant messaging database request processing routine 400 implemented by the online service 104 in accordance with an aspect of the present invention. At block 402, the user services application 108 obtains an instant message generated by a user on Web-connected client computing device 102 utilizing an instant messaging software application program. In an illustrative embodiment of the present invention, the user instant message is routed to an instant messaging account maintained and monitored by communication servers 106 for the online service 102. At decision block 404, a test is conducted to determine whether the user services application 108 recognizes the IM ID. In an illustrative embodiment of the present invention, the user services application 108 verifies known IM IDs via the user data repository 110. If the user is not associated with a known IM ID, the user services application 108 transmits an instant message at block 406 denying the request and the routine 400 ends. Alternatively, if the user is associated with IM ID, at decision block 408, the user services application 108 processes the instant message and determines whether the request is a query or command. In an illustrative embodiment, the user services application 108 parses the instant message for relevant query or command statements and composes a digest request. If the request is a query, the user services application 108 conducts the corresponding query from the user data repository and returns the data at block 410. If at decision block 408, the request is a command (reflective of an intent to make a change to a record in the database), at block 412, an optional additional user verification step may be required. If the user is authenticated, at block 414, the user services application 108 processes the database command and the routine 400 ends.

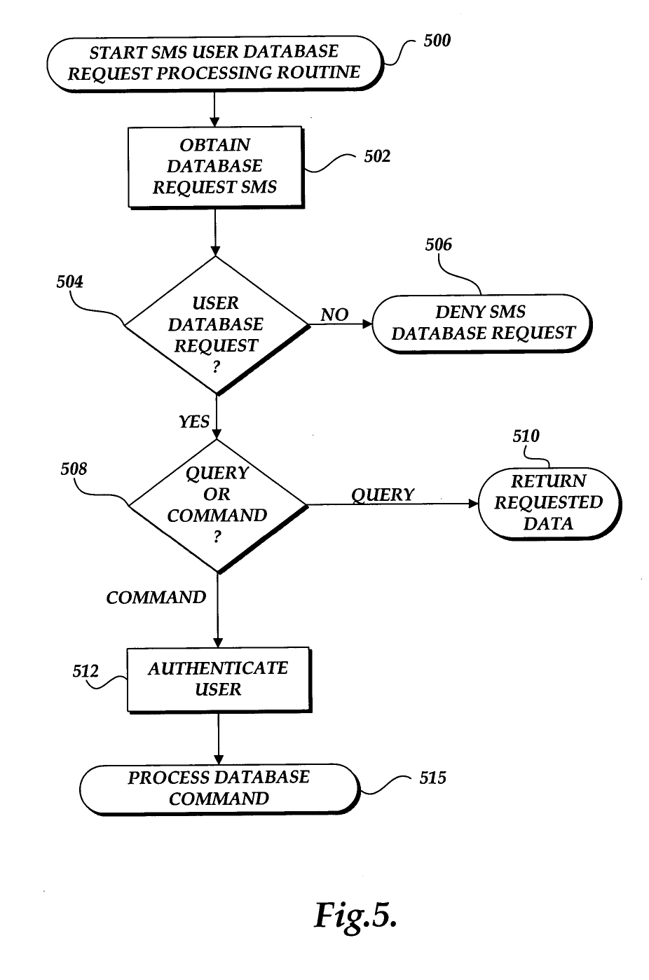

FIG. 5 is an illustrative processing a short message service database request processing routine 500 implemented by the online service 104 in accordance with an aspect of the present invention. At block 402, the user services application 108 obtains a short message service communication (e.g., a text message) generated by a user on Web-connected client computing device 102 utilizing a short message service software application program. In an illustrative embodiment of the present invention, a text message is generated by a user via an SMS-enabled mobile phone. As is known to those in skilled in the art, mobile-originated SMS text messages are sent to Short Message Service Center (“SMSC”). The SMSC stores the SMS text message and then delivers it to the destination user when they are available. In this embodiment, the SMS text message is sent to a short code associated with the online service 104.

At decision block 504, a test is conducted to determine whether the user services application 108 recognizes the SMS ID. In an illustrative embodiment of the present invention, the user services application 108 verifies known SMS IDs via the user data repository 110. If the user is not associated with a known SMS ID, the user services application 108 transmits an instant message at block 506 denying the request and the routine 400 ends. Alternatively, if the user is associated with SMS ID, at decision block 508, the user services application 108 processes the instant message and determines whether the request is a query or command. In an illustrative embodiment, the user services application 108 parses the instant message for relevant query or command statements and composes a digest request. If the request is a query, the user services application 108 conducts the corresponding query from the user data repository and returns the data at block 510. If at decision block 508, the request is a command (reflective of an intent to make a change to a record in the database), at block 512, an optional additional user verification step may be required. If the user is authenticated, at block 514, the user services application 108 processes the database command and the routine 500 ends.

In accordance with an aspect of the present invention, a user-generated query is composed in e-mail to retrieve public calendar data from an online service, which provides access to public and private calendar data. A public calendar is produced and maintained for unrestricted viewing by users. In the exemplary embodiment a movie theater, Maxiplex Cinemas has a public movie times calendar and maintains an e-mail interface for access to the public calendar information. Specifically, a user can send an e-mail to a dedicated e-mail address, such as maxiplex@trumba.com. As discussed above with regard to routine 300 (FIG. 3), the e-mail message can include a language-based query such as “today” in the body or subject line of the e-mail. The return e-mail from maxiplex@trumba.com might read “1:00 p.m. Sharks, 3:30 p.m. Fright Time, 5:00 p.m. Love Blooms, 7:15 p.m. Sharks, 9:00 Fright Time, 9:30 Love Blooms.” In a further aspect of the invention, a user might wish to access further information or initiate a transaction by linking to one or more external sources such as an online mapping and directions service, or an online ticketing service and the return e-mail (or IM) from the online service in response to a query such as “directions” or “tickets” could contain a hyperlink to access the third-party service.

In another aspect of the present invention, a user-generated query is composed in e-mail to retrieve private calendar data from an online service, which provides access to public and private calendar data. A private calendar is produced and maintained for restricted viewing and use. In the exemplary embodiment, a user, Jenny Lane, maintains a private calendar with online service. Using various communication media, the user can find out when her dentist appointment is through a query to her calendar. For example, the user can initiate a query, via e-mail, SMS, IM and the like that includes the query term “dentist”. Upon processing the query, the online service 104 can process the query against the user's private calendar and return a message such as: “dentist appointment 1:00 p.m. on Tuesday, Aug. 09, 2005.” In an additional aspect, the user could also manipulate one or more appointments, such as the dentist appoint, from her online calendar by sending the message with a command term, such as “cancel” or “move”.

In still a further aspect of the present invention, the system could also be implemented in such a way that any commands implemented on a calendar entry would be distributed to any specified recipients. With reference to the previous example, the online service could automate a message to the dentist in the event an appointment is cancelled. Adaptations of these exemplary queries to public and private calendars could also be implemented using IM or SMS using the routines described above.

In another illustrative embodiment, a radio station KXXX maintains a public calendar on Trumba web site. The KXXX calendar includes a play list database of songs by broadcast of times. A user might hear a song on the radio that they liked, note the time 10:20 a.m. and submit an e-mail query to KXXX kxxx@trumba.com with the message “10:20.” After a database search for songs played at or near 10:20 is performed, the user would receive an e-mail response such as “10:22 a.m. ‘Live Free’ by The Trees”. The e-mail could also include a link enabling the user to purchase or download the song from an external site.

While illustrative embodiments of the invention have been illustrated and described, it will be appreciated that various changes can be made therein without departing from the spirit and scope of the invention.

1. A method for interacting with an online database, the method comprising:
obtaining a text-based database request through an electronic communications medium to an online service, wherein the text-based database request cannot directly access the online service;
processing the text-based database request;
generating an output corresponding to the processing of the text-based database request; and
transmitting a result of the output in response to the text-based database request.

2. The method of claim 1, wherein processing of the text-based database request includes determining user access rights and processing the text-based database request according to the user access rights.

3. The method of claim 1, wherein the text-based database request corresponds to a database query.

4. The method of claim 1, wherein the text-based database request corresponds to a database command.

5. The method of claim 4 further comprising authenticating a user identity if the text-based database request corresponds to a database command.

6. The method of claim 1, wherein generating an output corresponding to the processing of the text-based database request corresponds to retrieving information from a user-specific data set.

7. The method of claim 1, wherein generating an output corresponding to the processing of the text-based database request corresponds to retrieving information from a multi-user data set.

8. The method of claim 1, wherein generating an output corresponding to the processing of the text-based database request corresponds to retrieving information from a linked online service.

9. The method of claim 1, wherein the online database is an online database of calendaring and scheduling data.

10. The method of claim 1, wherein the electronic communications medium is e-mail.

11. The method of claim 1, wherein the electronic communications medium is instant messaging.

12. The method of claim 1, wherein the electronic communications medium is SMS.

13. A method for interacting with an online database, the method comprising:
obtaining a database request through an electronic communications medium to a Web-based online service, wherein the text-based database request cannot directly access the online service;
determining whether the database request corresponds to a database query or a database command;
generating an output corresponding to the processing of the database request; and
transmitting a result of the output in response to a user.

14. The method of claim 13, wherein determining whether the database request corresponds to a database query or a database command includes determining user access rights and processing the text-based database request according to the user access rights.

15. The method of claim 13 further comprising authenticating a user identity if the text-based database request corresponds to a database command

16. The method of claim 13, wherein transmitting a result of the output in response to a user includes transmitting a result via the electronic communications medium using to transmit the database request.

17. The method of claim 13, wherein transmitting a result of the output in response to a user includes transmitting a result via a second electronic communications medium.

18. The method of claim 13, wherein transmitting a result of the output in response to a user includes transmitting a result to multiple users.

19. A method for interacting with an online calendaring database, the method comprising:
obtaining a text-based calendar request through an electronic communications medium to an online service, wherein the text-based calendar request cannot directly access the online service;
determining whether the calendar request corresponds to a calendar query or a calendar command;
generating an output corresponding to the processing of the text-based calendar request; and
transmitting a result of the output in response to the text-based calendar request.

20. The method of claim 19, wherein determining whether the calendar request corresponds to a calendar query or a calendar command includes determining user access rights and processing the text-based database request according to the user access rights.
